(19) United States
(12) Patent Application Publication
(10) Pub. No.: US 2005/0201235 A1
(43) Pub. Date: Sep. 15, 2005

(54) Information storage medium capable of controlling optimal recording power, and method and apparatus for recording/reproducing data on the same

(75) Inventors: Kyung-geun Lee, Seongnam-si (KR); Wook-yeon Hwang, Yangpyung-gun (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/072,650

(22) Filed: Mar. 7, 2005

Related U.S. Application Data
(60) Provisional application No. 60/552,719, filed on Mar. 15, 2004.

(30) Foreign Application Priority Data
Mar. 11, 2004 (KR) 2004-16620

(51) Int. Cl. G11B 5/09

(52) U.S. Cl. 369/47.53; 369/59.25

(57) ABSTRACT

An information storage medium of a recording/reproducing apparatus on which data may be recorded with optimal recording power, and a method and apparatus to record/reproduce data on the information storage medium. The information storage medium includes an optimal power control area composed of a plurality of unit areas on which a test to find optimal recording power is performed, wherein at least one unit area next to a unit area, in a direction of the test for optimal power control performed on the information storage medium, on which the test is last performed is skipped without recording data therein, and then a new test to find optimal recording power is performed from a unit area next to the unit area in which not data is recorded. Accordingly, an error caused between the unit area that is last tested and adjacent unit areas may be prevented when a new test to find optimal recording power is performed.

### CROSS-REFERENCE TO RELATED APPLICATIONS

This application claims the benefit of Korean Application No. 2004-16620, filed Mar. 11, 2004 in the Korean Intellectual Property Office and the benefit of U.S. Provisional Patent Application No. 60/552,719, filed Mar. 15, 2004, in the U.S. Patent and Trademark Office, the disclosures of which are incorporated herein by reference.

### BACKGROUND OF THE INVENTION

1. Field of the Invention

The present invention relates to an information storage medium on which data may be recorded with optimal recording power, and a method and apparatus to record/reproduce data with respect to the information storage medium.

2. Description of the Related Art

In general, information storage media are widely used as information recording media to be used with pickup devices that record/reproduce information without contacting the information storage media. Optical disks, which are information storage media, are classified into compact disks (CDs) and digital versatile disks (DVDs) according to their information recording capacity. 650 MB CD-Rs, CD-RWs, 4.7 GB DVD+RWs, etc., are optical disks on and from which data may be recorded, erased, and reproduced. HD DVDs or BLU-RAY disks having recording capacity of 15 GB or greater are under development, and super resolution disks capable of reproducing data overcoming the resolution limit are also under development.

As shown in FIG. 1, a conventional information storage medium includes a lead-in area 10 formed on an inner periphery of the medium, a data area 20 in which user data is recorded, and a lead-out area 30 formed on an outer periphery of the medium. The lead-in area 10 includes a disk information area 12 in which disk-related information, such as disk size, version number, manufacturer identification (ID), etc., is recorded. The lead-in area 10 further includes an optimal power control (OPC) area 15 used for a test to find optimal recording power, and a defect management area (DMA) 17 in which defect management information is recorded.

In order to find optimal recording power, whenever data needs to be recorded, a test is performed on the OPC area 15 by recording data with various levels of power. Accordingly, there are some cases where data is recorded with power higher than the optimal recording power. If data is recorded using the relatively higher recording power, grooves may be deformed, thereby badly affecting a servo signal. In particular, if data is recorded using higher power on a write-once information storage medium of dyed material, the information storage medium may have an even more adverse effect.

FIG. 2 is a schematic diagram to explain a method of performing a test on the OPC area 15 to find the optimal recording power. The OPC area 15 includes (n+1) units. In order to record/reproduce data on the information storage medium, a pickup moves along a track in a direction that addresses of the units increase.

The OPC test is performed whenever data is recorded. For example, if a first OPC test is performed on zero^{th} and first units, a second OPC test is performed from a unit right after the first unit. However, as described above, if the OPC test is performed using power higher than the optimal recording power, the OPC area may be damaged, and a radio frequency (RF) signal, an address signal, a servo signal, and so on may be deteriorated at the damaged OPC area. The damage and deterioration may affect units adjacent to a unit on which the OPC test is last performed. Accordingly, due to an error generated on a boundary between the damaged unit and a unit on which a new OPC test is to be performed, the new OPC test may be badly affected.

### SUMMARY OF THE INVENTION

Aspects of the present invention provide an information storage medium capable of performing a test to find optimal recording power under optimal conditions, and a method and apparatus for to record data on the information storage medium.

According to an aspect of the present invention, there is provided an information storage medium of a recording/reproducing apparatus. The medium comprises an optimal power control area having a plurality of unit areas on which a test to find optimal recording power is performed, wherein at least one unit area next to a unit area, in a direction of the test for optimal power control performed on the information storage medium, on which the test is last performed is skipped without recording data therein, and a new test to find optimal recording power is performed from a unit area next to the unit area in which no data is recorded.

According to another aspect of the present invention, there is provided an information storage medium of a recording/reproducing apparatus. The medium comprises an optimal power control area having a plurality of unit areas on which a test to find optimal recording power is performed, wherein data is recorded with the optimal recording power in at least one unit area next to a unit area, in a direction of the test for optimal power control performed on the information storage medium, on which the test is last performed, and then a new test to find optimal recording power is performed from a unit area next to the unit area in which the data is recorded with the optimal recording power.

According to an aspect of the invention, the unit area may be one of a frame, a sector, and an error correction code block.

Further, according to an aspect of the invention, the direction of the test for optimal power control may be opposite to a direction in which a pickup moves.

According to still another aspect of the present invention, there is provided a method of performing a test to find optimal recording power on an information storage medium of a recording/reproducing apparatus including an optimal power control area composed of a plurality of unit areas. The method comprises detecting a unit area, on which the test to find the optimal recording power is last performed, among the plurality of unit areas; skipping at least one unit area next to the unit area, in a direction of the test for optimal power control performed on the information storage medium, on which the test is last performed without recording data in the at least one unit area; and performing a new test to find optimal recording power from a unit area next to the unit area in which no data is recorded.

According to yet another aspect of the present invention, there is provided a method of performing a test to find optimal recording power on an information storage medium of a recording/reproducing apparatus including an optimal power control area composed of a plurality of unit areas. The method comprises performing the test to find the optimal recording power on the plurality of unit areas; recording data with the optimal recording power in at least one unit area next to a unit area, in a direction of the test for optimal power control performed on the information storage medium, on which the test is last performed; and performing a new test to find optimal recording power from a unit area next to the unit area in which the data is recorded with the optimal recording power.

According to a further aspect of the present invention, there is provided an apparatus to record/reproduce data on an information storage medium of a recording/reproducing apparatus including an optimal power control area composed of a plurality of unit areas by performing a test to find optimal recording power in a direction for optimal power control. The apparatus comprises a pickup to emit a beam to the information storage medium, to receive a beam reflected by the information storage medium, and to detect a unit area, on which the test to find the optimal recording power is last performed, among the plurality of unit areas; a recording/reproducing signal processing unit to receive and process the beam reflected by the information storage medium through the pickup; and a control unit to skip at least one unit area next to the unit area that is detected by the pickup as the unit area on which the test is last performed without recording data in the at least one unit area, and to perform a new test to find optimal recording power from a unit area next to the unit area in which no data is recorded.

According to another aspect of the present invention, there is provided an apparatus to record/reproduce data on an information storage medium of a recording/reproducing apparatus including an optimal power control area composed of a plurality of unit areas by performing a test to find optimal recording power in a direction for optimal power control. The apparatus comprises a pickup to emit a beam to the information storage medium and to receive a beam reflected by the information storage medium; a recording/reproducing signal processing unit to receive and process the beam reflected by the information storage medium through the pickup; and a control unit to record data with the optimal recording power in at least one unit area next to the unit area on which the test is last performed and to control the pickup to perform a new test to find optimal recording power from a unit area next to the unit area in which the data is recorded with the optimal recording power.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of a structure of an information area of a conventional information storage medium;

FIG. 2 is a schematic diagram to explain a method of performing a test on the conventional information storage medium to find optimal recording power;

FIG. 3A is a schematic diagram to explain a method of performing a test on an information storage medium to find optimal recording power according to an exemplary embodiment of the present invention;

FIG. 3B is a schematic diagram to explain a method of performing a test on an information storage medium to find optimal recording power according to another exemplary embodiment of the present invention; and

FIG. 4 is a schematic diagram of an apparatus to record/reproduce data on an information storage medium according to an exemplary embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

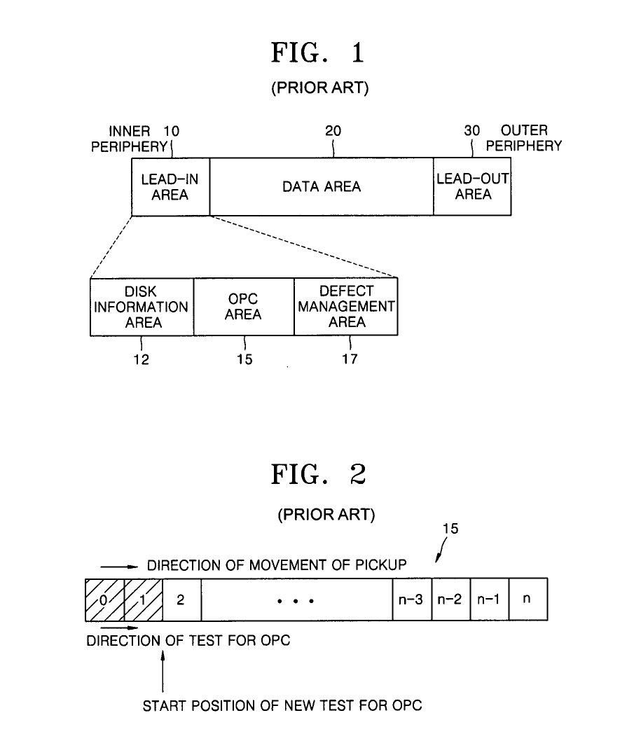

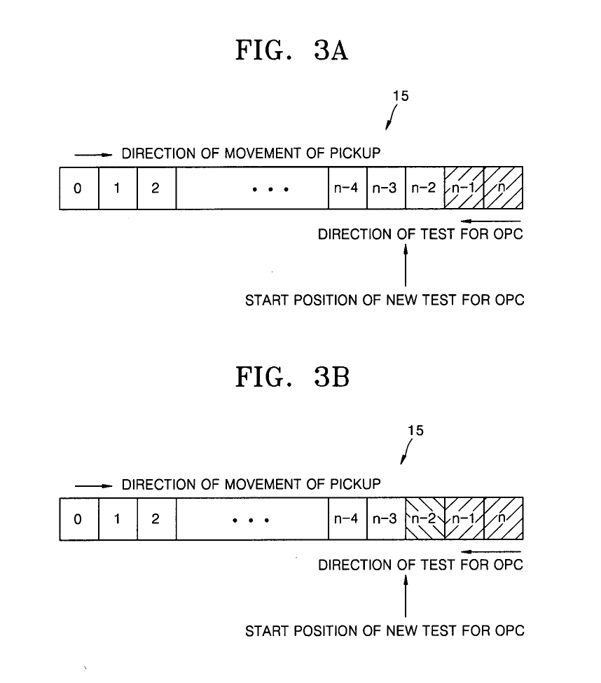

Referring to FIGS. 1 and 3A, an information storage medium, according to an aspect of the invention, includes a lead-in area 10, a data area 20, and a lead-out area 30. An optimal power control (OPC) area 15, used to find optimal recording power, is included in at least one of the lead-in area 10 and the lead-out area 30. The OPC area 15 includes a plurality of unit areas 0, 1, 2, . . . n used for a test to find the optimal recording power. An OPC test may be performed in a direction equal or opposite to a direction in which a pickup moves along a track of the information storage medium. FIG. 3A illustrates a case where the OPC test is performed in the direction opposite to the direction in which the pickup moves.

In the information storage medium according to the shown embodiment of the present invention, data is not recorded in at least one unit area right after a unit area on which the test is last performed. A new test for optimal recording power is performed on a unit area after the unit area where no data is recorded. Specifically, after an OPC test is performed at nth and n-1^{th} unit areas, data is not recorded in an n-2^{th} unit area next to the n-1^{th} unit area on which the test is last performed. A new OPC test is performed from the n-3^{th} unit area.

Although in the above embodiment, no data is recorded in the unit area next to the unit area on which the test is last performed and the new OPC test is performed from the n-3^{th} unit area, that data is not recorded in two or more unit areas next to the last tested unit area is possible. In such a case, once data is recorded the new OPC test is then performed.

Further, the test for OPC performed in the same direction as that in which the pickup moves may be carried out in the above way.

FIG. 3B illustrates an information storage medium according to another exemplary embodiment of the present invention, wherein a direction of a OPC test is opposite to a direction of movement of a pickup. In this embodiment, data is recorded using optimal recording power in at least one unit area next to a unit area on which an OPC test is last performed. A new test to find optimal recording power is performed from a unit area right after the unit area in which the data is recorded with the optimal recording power. Specifically, after an OPC test is performed at n^{th} and n-1^{th} unit areas, data is recorded using optimal recording power in an n-2^{th} unit area right after the n-1^{th} unit area that is last tested. A new OPC test is then performed from the n-2^{th} unit area. While being described as being recorded at the optimal recording power, it is understood that other powers can be used.

Although in the above embodiment, the data is recorded with the optimal recording power in one n-2^{th} unit area next to the last tested n-1^{th} unit area and then the new OPC test is performed from the n-2^{th} unit area, that the data is recorded with the optimal power in two or more unit areas next to the last tested unit area is possible. In such a case, once data is recorded, a new OPC test is then performed.

As is described above, since at least one unit area right after the last tested unit area is skipped and then the new OPC test is performed from the unit area after the skipped unit area, a drive may have a sufficient buffer time and may obtain a stable radio frequency (RF) signal or a stable address signal. Also, an error that may be caused on a boundary between the last tested area and adjacent areas may be prevented.

In aspects of the present invention, the unit area may be one of a frame, a sector, and an error correction code (ECC) block. Further, the direction in which the pickup moves relates to a track spiraling direction of the information storage medium. The track spiraling direction may extend from the inner periphery to the outer periphery of the information storage medium, or in contrast, from the outer periphery to the inner periphery. The present invention may be applied to both of these cases.

The information storage medium according to an aspect of the present invention may be applied to a write-once information storage medium and a rewritable information storage medium, and may also be applied to a single-layered information storage medium and a multi-layered information storage medium.

A method of recording data on an information storage medium by performing a test to find optimal recording power according to an exemplary embodiment of the present invention will now be explained. A unit area on which the test for the optimal recording power is last performed is detected among a plurality of unit areas constituting an OPC area in an information storage medium. Next, information about a direction in which the OPC test is performed on the tested information storage medium is read.

At least one unit area next, in the direction of the OPC test, to the unit area on which the OPC test is last performed is skipped without recording data therein. Next, a new test for optimal recording power is performed from a unit area next to the unit area in which no data is recorded.

Next, a method of recording/reproducing data according to another exemplary embodiment of the present invention will be explained. A test for optimal recording power is performed, and data is recorded using the optimal recording power in at least one unit area next to a unit area on which the test is last performed. A new test for new optimal recording power is performed from a unit area right after the unit area in which the data is recorded with the optimal recording power. Here, before the new test to find the new optimal recording power is performed, the last unit area in which the data is recorded with the optimal recording power should be detected.

A direction of the OPC test in the methods discussed above may be equal or opposite to a direction in which a pickup moves along a track of the information storage medium.

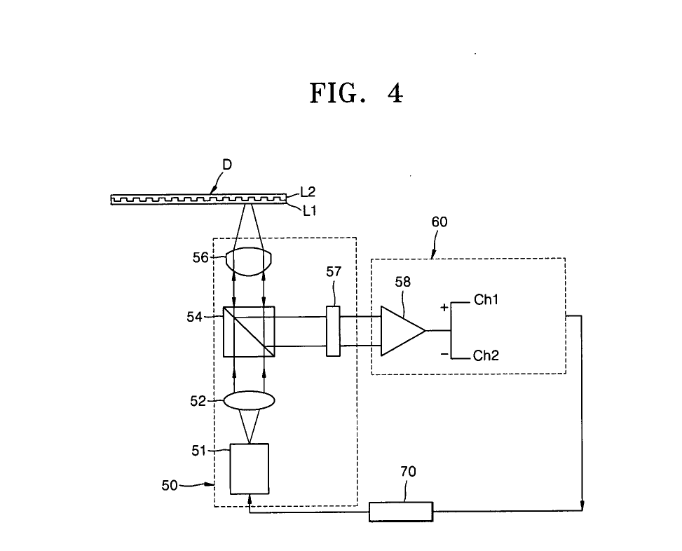

Next, an apparatus to record/reproduce data on an information storage medium (i.e., a drive), according to an exemplary embodiment of the present invention, will be explained with reference to FIG. 4. The recording/reproducing apparatus includes a pickup 50, a recording/reproducing signal processing unit 60, and a control unit 70. The recording/reproducing apparatus includes a laser diode 51 to emit light, a collimating lens 52 to collimate the light emitted from the laser diode 51, a beam splitter 54 to divert incident light, an objective lens 56 to focus light from the beam splitter 54 on an information storage medium D, and a photo detector 57.

Light, reflected by the information storage medium D, is reflected by the splitter 54 and is received by the photo detector 57, such as a quad photo detector. The light received by the photo detector 57 passes through an operational circuit unit 58 to be converted into an electrical signal and is output to a channel Ch1 where the electrical signal is detected as an RF signal, that is, a sum signal, and to a differential signal channel Ch2 where the electrical signal is detected as a push-pull signal. The control unit 70 controls the pickup 50 to perform an OPC test area formed on a predetermined portion of the information storage medium D so as to find optimal recording power before data is recorded on the information storage medium D.

To be specific, a wavelength of the light emitted from the laser diode 51 is 405 nm, a numerical aperture of the objective lens 56 is 0.85, a track pitch is 0.32 μm, a minimum length of a mark is 0.15 μm, and a modulation code is run-length-limited (RLL) (1, 7). Further, the optimal recording power depends on a jitter value or a modulation degree. When the jitter value is less than 6.5%, I2ₚₚ/I8ₚₚ is greater than 0.1, or I8ₚₚ/I8ₕ is greater than 0.4, the conditions for the optimal recording power are satisfied. Here, I2ₚₚ and I8ₚₚ represents a peak to peak value of a modulation degree with respect to 2T and 8T. I8ₕ represents a peak value of a modulation degree with respect to the 8T mark. When all of these conditions are satisfied, or either of the two conditions for the modulation degree and the condition for the jitter value are satisfied, data may be recorded with the optimal recording power.

In the meantime, the pickup 50 detects a unit area on which the OPC test is last performed. Here, the OPC test may be performed in a direction equal or opposite to a direction in which the pickup 50 moves along a track of the information storage medium. In particular, if the OPC test is performed in the opposite direction to the direction in which the pickup 50 moves along the track of the information storage medium, the pickup 50 detects an RF signal while moving along the track of the information storage medium D. A unit area from which the RF signal begins to be detected is determined as the unit area on which the OPC test is last performed. Accordingly, when the direction of movement of the pickup is opposite to the direction of the OPC test, the last tested area may be detected automatically while the pickup moves along the track.

The control unit 70 controls the pickup 50 not to record any data in at least one unit area next to the detected last unit area. Alternatively, the control unit 70 may control the pickup 50 to record data with the optimal power in at least one unit area next to the unit area that is last tested. In this case, a new test for optimal recording power is performed from a unit area right after the unit area in which the data is recorded with the optimal recording power.

The pickup 50 performs a new OPC test from a unit area next to the unit area in which no data is recorded or the unit area in which the data is recorded using the optimal recording power.

The control unit 70 permits a recording beam with the optimal power, which is obtained through the test, to be emitted to the information storage medium D through the pickup 50. Data is recorded on the information storage medium D with the recording beam. In order to reproduce the recorded data, a beam reflected by the information storage medium D is input to the photo detector 57 through the objective lens 56 and the beam splitter 54. The signal input to the photo detector 57 is then converted into an electrical sign and output as an RF signal.

While not required, it is understood that aspects of the invention can be embodied as computer software and/or firmware stored on a computer readable medium for use with at least one processor and/or computer.

As is described above, since the information storage medium and the method of performing a test to find optimal recording power skips at least one unit area next to a unit area on which the test for the optimal recording power is last performed or records data in the at least one unit area next to the last tested unit area with the optimal recording power, and then performs a new test for optimal recording power, an error caused on a boundary between the last tested unit area and adjacent unit areas may be prevented and the new test may be performed under optimal conditions.

Moreover, the apparatus to record/reproduce data on the information storage medium according to the present invention controls the pickup not to cause any error in performing a test to find optimal recording power whenever data is recorded on the information storage medium.

Although a few embodiments of the present invention have been shown and described, it would be appreciated by those skilled in the art that changes may be made in these embodiments without departing from the principles and spirit of the invention, the scope of which is defined in the claims and their equivalents.

1. An information storage medium of a recording/reproducing apparatus, the medium comprising:
an optimal power control (OPC) area having a plurality of unit areas on which the apparatus performs an OPC test to find optimal recording power,
wherein at least one unit area next to a previously tested unit area on which the OPC was performed and which is adjacent in a direction of the OPC test performed on the information storage medium is detected and skipped by the apparatus without recording data therein, and a new OPC test to find optimal recording power is performed in a next OPC unit area such that at least one unit area is between the next unit area and the previously tested unit area.

2. The information storage medium of claim 1, wherein the unit area is one of a frame, a sector, an error correction code block, or combinations thereof.

3. The information storage medium of claim 1, wherein the direction of the test for optimal power control is opposite to a direction in which a pickup moves while recording and/or reproduction of data.

4. The information storage medium of claim 1, further comprising a lead-in area formed on an inner periphery, a data area in which user data is recorded, and a lead-out area formed on an outer periphery, wherein the optimal power control area is in the lead-in area and/or the lead-out area.

5. An information storage medium of a recording/reproducing apparatus, the medium comprising:
an optimal power control (OPC) area having a plurality of unit areas on which the apparatus performs an OPC test to find an optimal recording power,
wherein data is recorded with the optimal recording power in at least one unit area next to a previously tested unit area on which the OPC test was previously tested and which is adjacent in a direction of the test for optimal power control performed on the information storage medium, and a new OPC test to find an optimal recording power is performed on another unit area next to the unit area in which the data is recorded with the optimal recording power.

6. The information storage medium of claim 5 wherein the unit area is one of a frame, a sector, an error correction code block, or combinations thereof.

7. The information storage medium of claim 5, wherein the direction of the test for optimal power control is opposite to a direction in which a pickup moves during recording and/or reproduction of data.

8. The information storage medium of claim 5, further comprising a lead-in area formed on an inner periphery, a data area in which user data is recorded, and a lead-out area formed on an outer periphery, wherein the optimal power control area is formed in at least one of the lead-in area and/or the lead-out area.

9. A method of performing a test to find optimal recording power on an information storage medium of a recording/reproducing apparatus including an optimal power control area having a plurality of unit areas, the method comprising:
detecting a tested unit area, on which the test to find the optimal recording power is last performed, among the plurality of unit areas;
skipping at least one unit area next to the tested unit area and which is adjacent in a direction of the test for optimal power control performed on the information storage medium, without recording data in the at least one skipped unit area; and
performing a new test to find optimal recording power from a unit area next to the skipped unit area in which no data is recorded.

10. The method of claim 9, wherein the unit area is one of a frame, a sector, an error correction code block, or combinations thereof.

11. The method of claim 9, wherein the direction of the test for optimal power control is opposite to a direction in which a pickup moves during recording and/or reproduction of data.

12. The method of claim 9, wherein the detecting the unit area comprises detecting a unit area where a radio frequency signal begins to be detected by the pickup so as to determine the unit area on which the test is last performed.

13. A method of performing a test to find optimal recording power on an information storage medium of a recording/reproducing apparatus including an optimal power control area having a plurality of unit areas, the method comprising:
performing the test to find the optimal recording power on at least one of the plurality of unit areas;
recording data with the optimal recording power in at least one unit area next to the at least one unit area on which the test is last performed and which is adjacent in a direction of the test for optimal power control performed on the information storage medium; and
performing a new test to find an optimal recording power on another unit area next to the unit area in which the data is recorded with the optimal recording power.

14. The method of claim 13, wherein the unit area is one of a frame, a sector, an error correction code block, or combinations thereof.

15. The method of claim 13, wherein the direction of the test for optimal power control is opposite to a direction in which a pickup moves during recording and/or reproduction of data.

16. The method of claim 13, further comprising detecting at least one unit area on which the test was last performed by the detecting a unit area where a radio frequency signal begins to be detected by the pickup.

17. An apparatus to record/reproduce data on an information storage medium of the apparatus including an optimal power control area having a plurality of unit areas by performing a test to find an optimal recording power in a direction for optimal power control, the apparatus comprising:
a pickup to emit a beam to the information storage medium, to receive a beam reflected by the information storage medium, and to detect a last tested unit area, on which the test to find the optimal recording power is last performed, among the plurality of unit areas;
a recording/reproducing signal processing unit to receive and process the beam reflected by the information storage medium through the pickup; and
a control unit to skip at least one unit area next to the last tested unit area as detected by the pickup as the unit area on which the test is last performed without recording data in the at least one unit area, and to perform a new test to find optimal recording power from a unit area next to the unit area in which no data is recorded.

18. An apparatus to record/reproduce data on an information storage medium of the apparatus including an optimal power control area having a plurality of unit areas by performing a test to find an optimal recording power in a direction for optimal power control, the apparatus comprising:
a pickup to emit a beam to the information storage medium and to receive a beam reflected by the information storage medium;
a recording/reproducing signal processing unit to receive and process the beam reflected by the information storage medium through the pickup; and
a control unit to record data with the optimal recording power in at least one unit area next to a last tested unit area on which the test is last performed and to control the pickup to perform a new test to find the optimal recording power from a unit area next to the unit area in which the data is recorded with the optimal recording power.

19. An information storage medium for use in a recording/reproducing apparatus, comprising:
an optimal power control area having a plurality of unit areas;
a first area in the plurality of unit areas on which a first test to find a first optimal recording power is performed;
a second area in the plurality of unit areas next to the first area on which any test to determine an optimal recording power is not performed; and
a third area on which a second test to find a second optimal recording power is performed, the third area being next to the second area such that the second area is between the first and third areas.

20. A method of finding optimal recording power on an information storage medium of a recording/reproducing apparatus including an optimal power control area composed of a plurality of unit areas, the method comprising:
detecting a first unit area, on which a test to find an optimal recording power is performed;
skipping a second unit area adjacent to the first unit area in a direction of the first test without performing the test; and
performing the test to find the optimal recording power on a third unit area adjacent to the second unit area.

21. An apparatus to record/reproduce data on an information storage medium of the apparatus including an optimal power control area composed of a plurality of unit areas by performing a test to find an optimal recording power, the apparatus comprising:
a pickup to emit a beam to the information storage medium, to receive a beam reflected by the information storage medium, and to detect a first unit area from among the plurality of unit areas as having had the test last performed thereon;
a recording/reproducing signal processing unit to receive and process the beam reflected by the information storage medium through the pickup; and
a control unit to control the apparatus to skip a second unit area, which is adjacent to the first unit area, and to perform the test on a third unit area adjacent to the second unit area such that the second unit area is between the first and third unit areas.

22. The apparatus according to claim 21, wherein the test is not performed on the second unit area.

23. The apparatus according to claim 21, wherein data is recorded on the second area.

24. The apparatus according to claim 21, wherein no data is recorded on the second area.
